(19) United States
(12) Patent Application Publication
(10) Pub. No.: US 2022/0371949 A1
(43) Pub. Date: Nov. 24, 2022

(54) AUTOMOTIVE GLAZING WITH NEUTRAL COLOR SOLAR CONTROL COATING

(71) Applicant: AGP America S.A., Ciudad de Panama (PA)

(72) Inventors: Mario Arturo MANNHEIM ASTETE, Lima (PE); Zhaoyu WANG, Lima (PE); José NUÑEZ-REGUEIRO, Lima (PE); Sebastián GÓMEZ, Lima (PE); Allan MAPLE, Lima (PE); Andris SIVARS, Lima (PE); Iván CORNEJO, Lima (PE); Andrés Fernando SARMIENTO, Lima (PE); Massimo MICHETTI, Lima (PE); Merlyn ROJAS VALLE, Lima (PE)

(21) Appl. No.: 17/827,732

(22) Filed: May 29, 2022

Related U.S. Application Data
(63) Continuation-in-part of application No. PCT/IB2020/061246, filed on Nov. 27, 2020.
(60) Provisional application No. 62/942,035, filed on Nov. 29, 2019.

(51) Int. Cl. C03C 17/34; C03C 27/04; C03C 23/00

(52) U.S. Cl. CPC C03C 17/3435; C03C 27/048; C03C 23/007; C03C 2217/213; C03C 2217/218; C03C 2217/228; C03C 2217/281; C03C 2217/734; C03C 2217/948; C03C 2218/154

(57) ABSTRACT

Due to the increased glazed area of modern vehicles, especially the large panoramic glass roofs, we have seen a substantial growth in the use solar control glass and coatings. The solar glass compositions and coatings are expensive to manufacture. While solar coatings are more efficient than compositions, they typically cannot be used on monolithic glazing as they are not durable. They must be applied to one of the surfaces on the inside of a laminate. Most of these products also introduce an undesirable color shift. The invention provides a coating that can be used on glass to produce a laminated or monolithic glazing with a neutral gray solar control coating which also has anti-reflective properties and low emissivity.

### FIELD OF THE INVENTION

This patent relates to the field of solar control automotive glazing.

### BACKGROUND OF THE INVENTION

A trend that has been growing in automotive design over the last several years has been an increase in the total area of the glazing. The increase in the glazed area is often accompanied by a reduction in vehicle weight due to the displacement of heavier materials. This has been a key part of the automotive strategy to meet regulatory requirements for higher fleet fuel efficiency as well as consumer demand for more environmentally friendly vehicles. Also, as automotive interiors have been getting smaller, the glazing area has been increased in an effort to offset the claustrophobic effect that can result from a reduction in cabin volume. The increase in vision area and natural light tend to give the cabin a more open and airier feel. As a result, large panoramic glass roofs have become a popular option on many models. In recent years, on models offered with a panoramic roof option in North American and Europe, the acceptance rate has been in the 30% to 40% range. In China, the rate has been close to 100% on some models.

The increase in glass area increases the solar load on the vehicle if conventional glazing is used. This may require a high capacity air conditioning unit which increases weight and reduces fuel efficiency. However, it is possible to reduce the solar load through the use of solar control glazing. By reducing the solar load on the vehicle substantial improvements can be made in energy consumption. This is especially important for electric vehicles where the improvement directly translates into an increase in the range of the vehicle which is a key consumer concern.

Two types of products have been used to limit the solar radiation into the vehicles. Solar absorbing glass compositions and solar reflecting glass coatings.

The first approach, glass compositions, makes use of glass that has been manufactured with certain metal oxides added to the glass composition. The additives absorb solar radiation preventing it from entering the passenger compartment. While a heat absorbing window can be very effective the glass will heat up from the absorbed energy and transfer energy to the passenger compartment through convection and radiation. Another drawback to glass compositions, in addition to their higher manufacturing cost, is that solar control glass compositions are only available in certain standard thicknesses. The compositions with low visible light transmission are not typically produced in the thinner versions needed for automotive glazing. They must be special ordered with a long lead-time and with a minimum order that can be in the 100s of tons.

The second and more efficient method, coatings and films, use infrared reflective (IR) coatings to reflect the solar radiation back to the environment allowing the glass to stay cooler. This is done using various infrared reflecting films and coatings. Typical examples are silver based or Transparent Conductive Oxides (TCO) such as ITO coatings. When on the exterior side of a glazing, these coating also have low Emissivity (low-E) properties. The primary drawback to these infrared coatings and films is that they are generally too soft to be mounted or applied to an exposed glass surface. They are easily damaged and will degrade when exposed to the environment. They must be fabricated as one of the internal layers of a laminated product to prevent damage and degradation of the film or coating.

One of the main advantages of a laminated window over a tempered monolithic glazing has been that a laminate can make use of these infrared reflecting coatings and films in addition to heat absorbing compositions and interlayers.

Infrared reflecting coatings include but are not limited to the various metal/dielectric layered coatings applied through Magnetron Sputtered Vacuum Deposition (MSVD) as well as others known in the art that are applied via pyrolytic, spray, chemical vapor deposition (CVD), dip and other methods.

A disadvantage of both solar control coatings and compositions is that they typically do not reflect and transmit uniformly across the visible light spectrum resulting in a color shift which may be undesirable. This is especially important when the glazing is used in conjunction with a camera system where is it important to accurately identify signal states. While a coating may be deleted from the camera field of view to alleviate the problem, this cannot be done with a glass composition, giving the coated products an advantage over the solar glass compositions.

An alternative to compositions and coating has been the use of tinted plastic interlayer. Besides being expensive, it is only available in a limited number of colors and light transmission levels, may require a considerably high minimum order, long lead times and is not as effective as coated glass.

Tinted PVB has been the only solution for production of glazing with very low visible light transmission as required for some privacy applications. Glass compositions and coating alone can only get down to visible light transmission of about 20%. Laminates with dark tinted PVB interlayer have been produced when lower than 20% is required. The darker interlayers have the same limitations as the lighter ones: price, minimum order quantity, availability.

One of the issues with darker glazed roofs is interior reflection. Typical soda lime glass reflects ^{˜}10% of the incident light. When the light transmission range is high, the reflection of the interior is not that noticeable. When the light transmission is low, the ratio of transmitted image intensity to the reflected becomes high and the reflected image can become distracting and objectionable. This has been addressed by applying an anti-reflective coating to the interior surface of the glazing. The cost of this additional coating is relatively high.

An internal combustion engine has an abundance of waste heat which has been used to heat the interior of the vehicle during cold weather operation. With electric and hybrid electric vehicles, this source of waste heat is not available and so the stored energy of the battery must be used to power resistive heating elements. The glazed roof is a major source of heat loss. Coatings with a low emissivity have been used in commercial and residential building glazing for many years to improve the cold weather insulation of the glazing. These low-E coatings are starting to be used in automotive glazing for the same reasons. Also, a low-E coating on a roof, even in a vehicle with an internal combustion engine can improve passenger comfort by eliminated drafts caused by the cold glass. The cost of this additional coating is relatively high.

U.S. Pat. No. 5,112,675 disclosed a solar control coating stack of Glass/TiC/ITO to provide solar protection via absorbent layer of TiC and IR Reflective layer of ITO. In this patent, ITO is unprotected and directly exposed to air. The claimed ITO thickness is less than 50 nm.

Patent application US20150070755A1 disclosed a solar control coating stack of Glass/Si₃N₄/NiCr/ITO/NiCr/Si₃N₄. This patent application claimed NiCr layer with a thickness of between 0.5 and 3 nm. It also claimed ITO layer with a thickness of between 100 and 250 nm. The coating stack in this patent application does not have AR function. A coated automotive glazing with a durable neutral grey solar control coating along with an economical and effective method of manufacture would be desirable.

### BRIEF SUMMARY OF THE INVENTION

This invention relates to a solar control glazing comprising at least one glass substrate with coating stack providing an exposed surface durable, solar control, anti-reflection (AR) coating with a neutral gray color. The coating stack also has the additional benefits in that it has a low emissivity and low reflectivity. The coating reflects in the infrared spectral range while transmitting in the visible. The visible light transmission can be adjusted across a wide range of the spectrum to suit the application without changing the coater configuration. An anti-fingerprint coating may also be applied over the coating without degradation of the coating composition or its functionality.

The solar protection function is enabled by an absorbent layer and an infrared (IR) reflective layer in the coating stack on the surface of glass. The coating stack on the glass comprises the sequence of layers starting from the surface of glass substrate: a barrier layer to stop the alkali metal ions migration from the glass substrate which is silicon nitride or silicon oxynitride with a thickness of between 10 and 100 nm, a IR reflective layer of Indium Tin Oxide (ITO) with a thickness of between 50 and 200 nm, a thin absorbent layer of metal including a metal alloy or partially oxidized metal with thickness between 3 and 20 nm, and in one embodiment with a thickness between 3 and 10 nm, a sub-stack of dielectric layers with AR function with alternating refractive index HLHL or MHL (from the glass surface). In one embodiment of the present disclosure, a barrier layer is deposited over surface of the glass. The subsequent layers are IR reflective layer, thin absorbent layer, and a sub-stack of dielectric layers having high index of refraction and low index of refraction deposited in an alternating pattern. The thin absorbent layer can be placed immediately below or above the ITO layer. In certain example embodiments, the AR function sub-stack comprises dielectric layers of HL refractive index such as Nb₂O₅\SiO₂. In certain example embodiments, the AR function sub-stack comprises dielectric layers of MHL refractive index such as SiOₓN_{y}\Nb₂O₅\SiO₂. The coated glass article uses glass substrate. Additionally, the coating stack may comprise of thin protective nitride-based layer, on top of the absorptive metal layer to protect against oxidation. This thin protective layer may be preferably silicon nitride.

The absorbent metal layer may be varied in thickness and composition to precisely control the level of visible light transmission. By increasing the thickness of the absorbent metal layer, the visible light transmission decreases such as illustrated by embodiments two and six.

The method of manufacture is comprised of a set of sequential steps illustrated in the flow chart of FIG. 7. These are the essential steps required for both a laminated and a tempered product. In all cases, the substrate 32 must be prepared. At the minimum this includes the steps of inspecting the glass and cleaning the glass. The coating may be applied to the as-received uncut glass sheet. When this is the case, the substrate 32 may also require the steps cutting to size, edging, painting and firing prior as a part of the substrate 32 preparation step. The coating is then applied to the substrate 32 in the next step. In the final step, the substrate is formed to its final shape. This may be performed by thermal bending or in the case of a laminate, it may be formed by means of cold bending.

While the full benefit is realized when applied to the vehicle interior face of the glazing, the coating may also be applied to surfaces two or three of a laminate and as such is also included in the scope of what is claimed.

This coating stack 19 along with the unique article of manufacture produced with this stack are claimed as a part of this application.

### ADVANTAGES

Improved aesthetics
Precise control of visible light transmission level
Neutral color
Suitable for application to exposed surfaces
Reduced solar load
Low emissivity when applied to an exposed surface
Privacy
Anti-reflective
Easy-cleaning

### BRIEF DESCRIPTION OF THE DRAWINGS

FIG. 1A shows a cross section of a typical laminated automotive glazing.

FIG. 1B shows a cross section of a typical laminated automotive glazing with performance film.

FIG. 1C shows a cross section of a typical tempered monolithic automotive glazing.

FIG. 2 shows an exploded view of a tempered coated roof.

FIG. 3 shows an exploded view of a laminated coated roof.

FIG. 4A shows a graph of a coating's light transmittance.

FIG. 4B shows a graph of a coating's light reflectance.

FIG. 5A shows a diagram of a coating layers stack and their referential thicknesses.

FIG. 5B shows an optics and thermal performance matrix of a coating.

FIG. 6 shows a generic coating stack.

FIG. 7 shows a flow chart of the coating deposition process.

### REFERENCE NUMERALS OF DRAWINGS

2 Glass

4 Plastic bonding layer (interlayer)

6 Obscuration/Black frit

12 Film

18 Coating

19 Coating stack

21 Coating layer 1

22 Coating layer 2

23 Coating layer 3

24 Coating layer 4

25 Coating layer 5

26 Coating layer 6

27 Coating layer 7

32 Surface of glass substrate

42 Neutral Gray AR coating of invention

101 Surface one

102 Surface two

103 Surface three

104 Surface four

201 Outer layer

202 Inner layer

### DETAILED DESCRIPTION OF THE INVENTION

The following terminology is used to describe the glazing of the invention.

A panoramic roof is a vehicle roof glazing which comprises a substantial area of the roof over at least a portion of both the front and rear seating areas of the vehicle. A panoramic roof may be comprised of multiple glazings and may be laminated or monolithic.

The steps of the method must be executed in the order shown, however, additional steps which may be required depending upon the specific glazing and coating may not be shown as well as optional steps. The steps must be performed sequentially but are not required to be performed immediately after each other and i. e. execution of said steps can be separated in space and time.

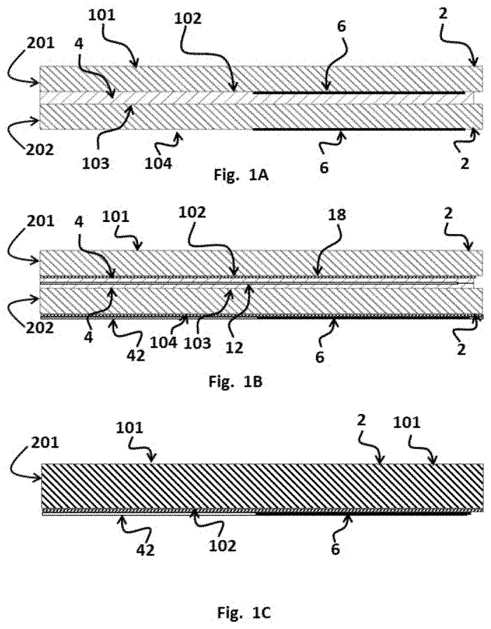

Typical automotive laminated glazing cross sections are illustrated in FIGS. 1A and 1B. A laminate is comprised of two layers of glass, the exterior or outer, 201 and interior or inner, 202 that are permanently bonded together by a plastic bonding layer 4. In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic layer 4. An obscuration 6 may be also applied to the glass. Obscurations are commonly comprised of black enamel frit printed on either the number two 102 or number four surface 104 or on both. The laminate may have a coating 18 on one or more of the surfaces. The laminate may also comprise a film 12 laminated between at least two plastic layers 4.

FIG. 1C shows a typical tempered automotive glazing cross section. Tempered glazing is typically comprised of a single layer of glass 201 which has been heat strengthened. The glass surface that is on the exterior of the vehicle is referred to as surface one 101 or the number one surface. The opposite face of the exterior glass layer 201 is surface two 102 or the number two surface. The number two surface 102 of a tempered glazing is on the interior of the vehicle. An obscuration 6 may be also applied to the glass. Obscurations are commonly comprised of black enamel frit printed on the number two 102 surface. The glazing may have a coating 18 on the surface one 101 and/or surface two 102.

FIGS. 1B and 1C show the coating 42 of the invention. In FIG. 1B, a laminated cross section, the coating 42 is applied to the surface four 104 of the inner glass layer 202. The coating 42 is applied over the AR coating and the black frit 6. In FIG. 1C, the monolithic tempered cross section, the coating 42 is applied to the surface two 102 of the vehicle interior face of the single glass layer 201. The coating 42 is applied over the AR coating and the black frit 6.

The term “glass” can be applied to many organic and inorganic materials, include many that are not transparent. For this document we will only be referring to nonorganic transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a forming a miscible homogeneous fluid.

The types of glass that may be used include but are not limited to: the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent.

Most of the glass used for containers and windows is soda-lime glass. Soda-lime glass is made from sodium carbonate (soda), calcium carbonate (lime), dolomite, silicon dioxide (silica), aluminum oxide (alumina), and small quantities of substances added to alter the color and other properties.

Borosilicate glass is a type of glass that contains boric oxide. It has a low coefficient of thermal expansion and a high resistance to corrosive chemicals. It is commonly used to make light bulbs, laboratory glassware, and cooking utensils.

Aluminosilicate glass is made with aluminum oxide. It is even more resistant to chemicals than borosilicate glass and it can withstand higher temperatures. Chemically tempered Aluminosilicate glass is widely used for displays on smart phones and other electronic devices.

Lithium-Aluminosilicate is a glass ceramic that has very low thermal expansion, optical transparency and high. It typically contains 3-6% Li₂O. It is commonly used for fireplace windows, cooktop panels, lenses and other applications that require low thermal expansion.

A wide range of coatings, used to enhance the performance and properties of glass, are available and in common use and can be used in the production of the glazing of the invention. These include but are not limited to anti-reflective, hydrophobic, hydrophilic, self-healing, self-cleaning, anti-bacterial, anti-scratch, anti-graffiti, anti-fingerprint and anti-glare.

Methods of coating application include Magnetron Sputtered Vacuum Deposition (MSVD) as well as others known in the art that are applied via pyrolytic, spray, chemical vapor deposition (CVD), dip, sol-gel and other methods.

The glass layers are formed using gravity bending, press bending, cold bending or any other conventional means known in the art. In the gravity bending process, the glass flat is supported near the edge of glass and then heated. The hot glass sags to the desired shape under the force of gravity. With press bending, the flat glass is heated and then bent on a full of partial surface mold. Air pressure and vacuum are often used to assist the bending process. Gravity and press bending methods for forming glass are well known in the art and will not be discussed in detail in the present disclosure.

The coated substrate of the invention may be formed by the method of cold bending. Cold bending is a relatively new technology. As the name suggests, the glass is bent, while cold to its final shape, without the use of heat. On parts with minimal curvature a flat sheet of glass can be bent cold to the contour of the part. This is possible because as the thickness of glass decreases, the sheets become increasingly more flexible and can be bent without inducing stress levels high enough to significantly increase the long-term probability of breakage. Thin sheets of annealed soda-lime glass, in thicknesses of about 1 mm, can be bent to large radii cylindrical shapes (greater than 6 m). When the glass is chemically, or heat strengthened the glass can endure much higher levels of stress and can be bent along both major axis. The process is primarily used to bend chemically tempered thin glass sheets (<=1 mm) to shape.

Cylindrical shapes can be formed with a radius in one direction of less than 4 meters. Shapes with compound bend, that is curvature in the direction of both principle axis can be formed with a radius of curvature in each direction of as small as approximately 8 meters. Of course, much depends upon the surface area of the parts and the types and thicknesses of the substrates.

The cold bent glass will remain in tension and tend to distort the shape of the bent layer that it is bonded to. Therefore, the bent layer must be compensated to offset the tension. For more complex shapes with a high level of curvature, the flat glass may need to be partially thermally bent prior to cold bending.

The glass to be cold bent is placed with a bent to shape layer and with a bonding layer placed between the glass to be cold bent and the bent glass layer. The assembly is placed in what is known as a vacuum bag. The vacuum bag is an airtight set of plastic sheets, enclosing the assembly and bonded together it the edges, which allows for the air to be evacuated from the assembly and which also applies pressure on the assembly forcing the layers into contact. The assembly, in the evacuated vacuum bag, is then heated to seal the assembly. The assembly is next placed into an autoclave which heats the assembly and applies high pressure. This completes the cold bending process as the flat glass at this point has conformed to the shape of the bent layer and is permanently affixed. The cold bending process is very similar to a standard vacuum bag/autoclave process, well known in the art, except for having an unbent glass layer added to the stack of glass.

The plastic bonding layer 4 has the primary function of bonding the major faces of adjacent layers to each other. The material selected is typically a clear thermoset plastic. For automotive use, the most commonly used bonding layer 4 is polyvinyl butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over a wide range over the temperature range required for an automobile. Only a small number of plasticizers are used. They are typically linear dicarboxylic esters. Two in common use are di-n-hexyl adipate and tetra-ethylene glycol di-n-heptanoate. A typical automotive PVB interlayer is comprised of 30-40% plasticizer by weight.

Interlayers are available with enhanced capabilities beyond bonding the glass layers together. The invention may include interlayers designed to dampen sound. Such interlayers are comprised whole or in part of a layer of plastic that is softer and more flexible than that normally used. The interlayer may also be of a type which has solar attenuating properties.

A wide variety of films are available that can be incorporated into a laminate. The uses for these films include but are not limited to: solar control, variable light transmission, increased stiffness, increased structural integrity, improved penetration resistance, improved occupant retention, providing a barrier, tint, providing a sunshade, color correction, and as a substrate for functional and aesthetic graphics. The term “film” shall include these as well as other products that may be developed or which are currently available which enhance the performance, function, aesthetics or cost of a laminated glazing. Most films do not have adhesive properties. To incorporate into a laminate, sheets of plastic interlayer are needed on each side of the film to bond the film to the other layers of the laminate.

To control the level of light transmission through the laminate, there are many technologies available: electrochromic, photochromic, thermochromic and electric field sensitive films which are designed to be incorporated into laminated glass. Of interest are suspended particle device (SPD) films and polymer dispensed liquid crystal (PDLC) films which can quickly change their light transmittance in response to an electrical field. These films can be laminated in between the glass layers of the automotive glazing.

Anti-reflective coatings are produced by alternating layers of materials having different indexes of refraction. In general, such coatings are described in terms of the index of refraction of each material which are conveniently designated as High (H) with an index of refraction equal or above 1.8, Medium (M), with index of refraction between 1.6 and 1.8 or Low (L), with index of refraction equal or below 1.6. A coating described as a HLHL would be comprised alternating high, low, high and low indexes of refraction. These materials are well known in the art and any other material in the same HML group may be substituted for another without departing from the intent of the invention.

### DESCRIPTION OF EMBODIMENTS

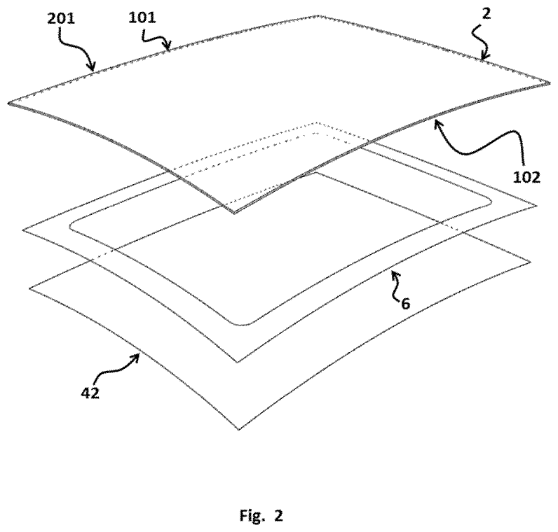

Tempered monolithic embodiments are shown as an exploded view in FIG. 2.

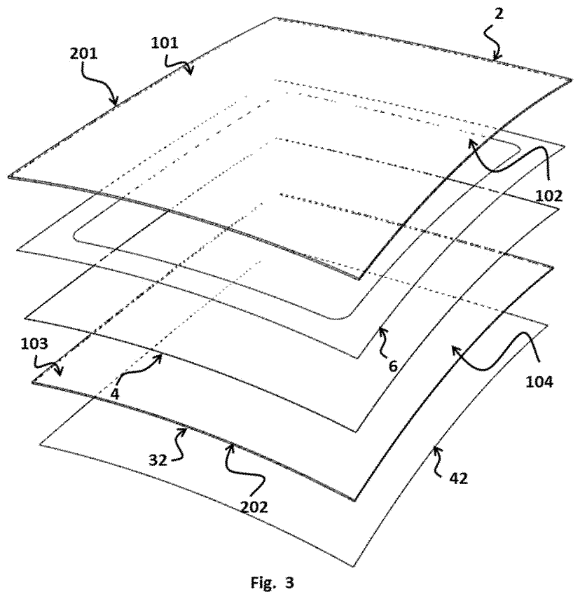

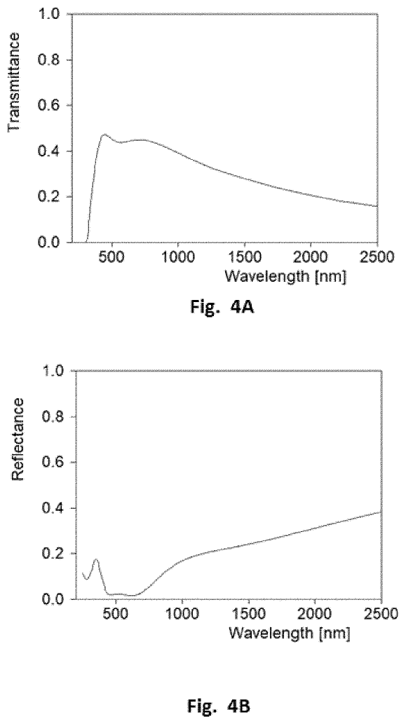

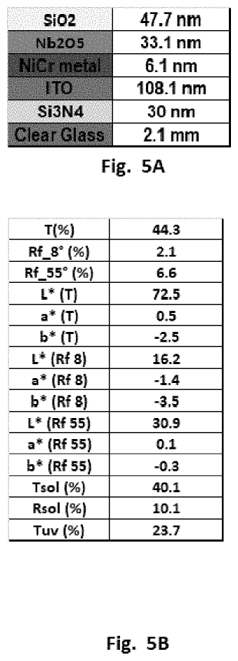

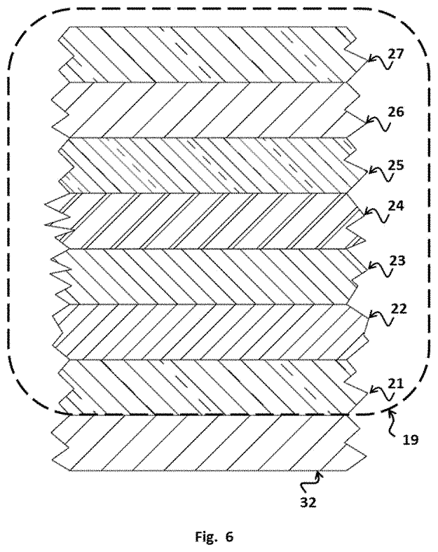

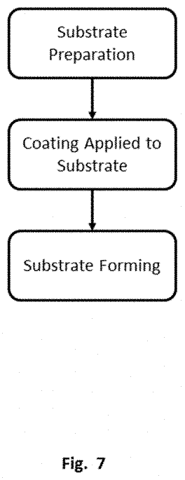

Laminated embodiments are shown in FIG. 3.
1. In certain example embodiments, a clear, high alumina silicate, chemically tempered glass with a thickness of less than 1 mm is used for the inner glass layer 202. The outer glass layer is comprised of a clear 2.1 mm thick annealed soda-lime glass. The glass layer 202, with coating applied to surface four 104, has a gray appearance with:
   light transmission (Tvis) less than 60%,
   film side reflection (Rf) less than 6%,
   film side neutral color (−5<Rf-a*<0, −5<Rf-b*<0).
2. A typical example of this invention comprises a clear, thermally tempered, soda-lime, 3.2 mm thick, monolithic coated article that has the following layer stack 19:
   Si₃N₄(30 nm) 21
   ITO(108 nm) 22
   NiCr(6 nm) 23
   Nb₂O₅(33 nm) 24
   SiO₂(48 nm) 25
And has the following optics and thermal performance matrix:
   TL=44.3%,
   Rf (8°)=2.1%,
   Rf-a*=−1.4,
   Rf-b*=−3.5,
   Tsol=40.1%,
   Rsol=10.1%.
The monolithic coated article looks gray with neutral color. The coated article is laminated with another pane of clear glass (2.1 mm) using PVB to form a sunroof configuration. The Gray low-E plus AR coating is on the inner surface of the laminate (surface four 104). The Gray low-E plus AR coating stack 19 is deposited via Magnetron Sputter technology. Additionally, the gray low-E plus AR coating could comprise the following additional layers 26 Nb₂O₅ and 27 SiO₂ having a HLHL dielectric stack pattern such as depicted in FIG. 6.
3. In certain example embodiments, the Gray low-E plus AR coating is further coated with Anti-Fingerprint (AF) liquid coating.
4. In certain example embodiments, the laminated sunroof structure has a PDLC or SPD film laminated between the glass and PVB. A typical example is: AF/SiO₂/Nb₂O₅/NiCr/ITO/Si₃N₄/Inner glass/PVB/PDLC/PVB/Outer glass or AF/SiO₂/Nb₂O₅/NiCr/ITO/Si₃N₄/Inner glass/PVB/SPD/PVB/Outer glass
5. A monolithic embodiment:
   a. 3.2 mm tempered soda lime glass coated with Si₃N₄(30 nm)/ITO(108 nm)/NiCr(6 nm)/Nb₂O₅(33 nm)/SiO₂(48 nm) on the surface two 102.
6. Another monolithic embodiment is a 3.8 mm tempered clear soda lime glass coated with a Gray low-E coating as follows starting from the glass:
   Si₃N₄(23 nm) 21
   ITO(102 nm) 22
   NiCr(16 nm) 23
   Nb₂O₅(24 nm) 24
   SiO₂(99 nm) 25
   And has the following optics and thermal performance matrix:
   TL=18.5%,
   Rf (8°)=24.6%,
7. A laminated glazing wherein the inner glass layer is a 2.1 mm annealed clear soda-lime glass coated with a Gray low-E plus AR coating from embodiment 6 on surface four 104, the interlayer is a clear PVB and the outer glass layer is a 2.1 mm annealed clear soda-lime glass. The transmitted over reflected light can be characterized by the A parameter wherein A=TL/RL(8°). For Standard low-E sputtered coatings have A in the range of 0.4<A<2.0. For the laminated stack from this embodiment A=0.75.
8. A laminated embodiment comprising:
   a. 1.0 mm chemically tempered alumina-silicate inner glass layer coated with AF/SiO₂/Nb₂O₅/NiCr/ITO/Si₃N₄ on the surface four 104,
   b. 0.76 mm PVB,
   c. PDLC(SPD),
   d. 0.76 mm PVB,
   e. 2.1 clear soda-lime outer glass layer.

What is claimed is:

1. A vacuum sputtered coating deposited upon a glass layer of a glass substrate with a stack comprising in order from the layer closest to the glass substrate:
a. a barrier layer to stop the alkali metal ions migration from the glass substrate which is silicon nitride or silicon oxynitride with a thickness of between 10 and 100 nm;
b. an Infra Red (IR) reflective layer of Indium Tin Oxide (ITO) with a thickness of between 50 and 200 nm;
c. a thin absorbent layer comprising metal or partially oxidized metal with thickness of between 3 and 20 nm, and placed either below or above the ITO layer; and
d. an anti-reflective sub-stack of alternating refractive index dielectric layers wherein the sub-stack comprises alternating refractive index with a configuration selected from the group of:
i. High, Low, High, Low (HLHL); or
ii. Medium, High, Low (MHL); or
iii. High, Low (HL).

2. The coating of claim 1, wherein the anti-reflective sub-stack is comprised of Nb₂O₅\SiO₂.

3. The coating of claim 1, wherein the anti-reflective sub-stack is comprised of SiOₓN_{y}\Nb₂O₅\SiO₂.

4. The coating of claim 1, further comprising a thin protective nitride-based layer on top of the absorptive metal layer to protect against oxidation, preferably silicon nitride.

5. The coating of claim 1, wherein the thin absorbent layer is comprised of NiCr or NbZr.

6. The coating of claim 1, wherein the thin absorbent layer has thickness of between 3 and 10 nm.

7. An automotive glazing comprising at least one glass layer with the coating of claim 1, wherein said at least one glass layer has two oppositely disposed major surfaces, one of these two major surfaces is an interior surface which faces the interior of the vehicle cabin, and wherein the vacuum sputtered coating is applied on said interior surface.

8. The automotive glazing of claim 7, wherein said at least one glass layer is a monolithic thermally tempered glazing.

9. The automotive glazing of claim 7, further comprising:
an outer glass layer and an inner glass layer; and
at least one plastic bonding layer placed between the outer and inner glass layers;
wherein the vacuum sputtered coating is applied on the interior surface of the inner glass layer.

10. The automotive glazing of claim 9, wherein at least one of the glass layers is chemically tempered.

11. The automotive glazing of claim 7, wherein the glazing is a roof glazing.

12. The automotive glazing of claim 7, wherein the total visible light transmission is less than 60%, preferably less than 40%, more preferably less than 20%.

13. The automotive glazing of claim 7, wherein the total visible light reflection is less than 10%, more preferably less than 5%.

14. The automotive glazing of claim 9, wherein the thickness of the inner glass layer is less than 1.0 mm.

15. The automotive glazing of claim 9, wherein the inner glass layer is cold bent.

16. The automotive glazing of claim 7, further comprising an anti-fingerprint coating applied to the interior surface facing the interior of the vehicle cabin.

17. The automotive glazing of claim 7, further comprising a suspended particle device (SPD) or a polymer dispensed liquid crystal (PDLC) film.

18. A vacuum sputtered coating deposited upon a glass layer of a glass substrate with a stack comprising in order from the layer closest to the glass substrate:
a. a barrier layer to stop the alkali metal ions migration from the glass substrate which is silicon nitride or silicon oxynitride with a thickness of between 10 and 100 nm;
b. an Infra Red (IR) reflective layer of Indium Tin Oxide (ITO) with a thickness of between 50 and 200 nm;
c. a thin absorbent layer comprising metal or partially oxidized metal with thickness of between 3 and 10 nm, and placed either below or above the ITO layer; and
d. an anti-reflective sub-stack of alternating refractive index dielectric layers wherein the sub-stack comprises alternating refractive index with a configuration selected from the group of:
i. High, Low, High Low (HLHL); or
ii. Medium, High, Low (MHL); or
iii. High, Low (HL).
